(19) United States
(12) Patent Application Publication
(10) Pub. No.: US 2026/0165298 A1
(43) Pub. Date: Jun. 18, 2026

(54) HERDING BALL

(71) Applicant: Race & Herd Corporation, Houston, TX (US)

(72) Inventor: Lim Ruiqi, Houston, TX (US)

(21) Appl. No.: 18/981,803

(22) Filed: Dec. 16, 2024

(51) Int. Cl. A01K 15/02; B32B 1/00; B32B 3/08; B32B 27/06; B32B 27/32

(52) U.S. Cl. CPC A01K 15/025; B32B 1/00; B32B 3/08; B32B 27/06; B32B 27/322; B32B 2307/54; B32B 2307/581; B32B 2307/7242; B32B 2307/7265; B32B 2307/7375; B32B 2307/7376; B32B 2410/00

(57) ABSTRACT

A method or product may include an inflatable polyvinyl chloride (PVC) inner ball comprising a valve and stopper plug configured for filling the inner ball with air and an outer layer at least partially surrounding the inner ball, wherein the outer layer comprises a zip system comprising a hood configured to enclose the outer layer around the inner ball.

### TECHNICAL FIELD

The embodiments generally relate to the technical field of herding balls.

### BACKGROUND

Conventional herding training may require rural areas with access to livestock or standard dog toys that are unsuitable for simulating herding behaviors. Traditional training methods lack portability, durability, and ease of use, particularly for those living in urban areas. Additionally, many existing training balls used for herding were made of hard materials that can grind down an animal's teeth during use. These hard materials are unsuitable for extended play or training sessions.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, variations of the disclosed tooth-safe herding ball may include an inflatable polyvinyl chloride (PVC) inner ball comprising a valve and stopper plug configured for filling the inner ball with air and an outer layer at least partially surrounding the inner ball, wherein the outer layer comprises a zip system comprising a hood configured to enclose the outer layer around the inner ball.

In one aspect, variations of the disclosed tooth-safe herding ball may include a puncture-resistant inflatable 1,575 micrometer thick polyvinyl chloride (PVC) inner ball comprising a valve and stopper plug configured for filling the inner ball with air and a puncture-resistant outer layer at least partially surrounding the inner ball, wherein the outer layer comprises a nylon and polyester blend fabric, and a zip system comprising a hood configured to enclose the outer layer around the inner ball.

In one aspect, variations of the disclosed tooth-safe herding ball may include a puncture-resistant inflatable 1,575 micrometer thick polyvinyl chloride (PVC) inner ball comprising a valve and stopper plug configured for filling the inner ball with air; and a puncture-resistant outer layer at least partially surrounding the inner ball, wherein the outer layer comprises a nylon and polyester blend fabric comprising a load limit of approximately 2,200 lbs. and a zip system comprising a hood configured to enclose the outer layer around the inner ball.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a tooth-safe herding ball, according to some embodiments;

FIG. 2 illustrates a cross-sectional view of a tooth-safe herding ball; according to some embodiments;

FIG. 3 illustrates an exploded view of a tooth-safe herding ball; according to some embodiments;

FIG. 4 illustrates a partial view of a tooth-safe herding ball; according to some embodiments;

FIG. 5 illustrates a partial view of a tooth-safe herding ball; according to some embodiments;

FIG. 6 illustrates a partial view of a tooth-safe herding ball; according to some embodiments;

FIG. 7-9 illustrate a partial view of a tooth-safe herding ball; according to some embodiments;

FIGS. 10 and 11 illustrate a tooth-safe herding ball, according to some embodiments;

FIG. 12 illustrates a tooth-safe herding ball, according to some embodiments; and

FIGS. 13-16 illustrate a tooth-safe herding ball training kit, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

According to embodiments, a tooth-safe herding ball for dog and horse well-being and mental stimulation may include a unique construction, consisting of an inflatable polyvinyl chloride (PVC) inner ball encased in a durable outer cover. The outer cover may include a two-layer waterproof nylon and polyester blend is quilted for enhanced durability and secured with an auto-locking zipper. The tooth-safe herding ball's construction may include advanced stitching techniques, including double welt Seam and slot Seams to ensure longevity even during intense play. According to some embodiments, the tooth-safe herding ball improves upon existing technology by addressing key limitations such as accessibility and potential tooth damage associated with traditional herding training devices and methods.

In embodiments, the tooth-safe herding ball may include a repair kit, a training clicker, and a training guide. The training guide may facilitate bridging the knowledge gap for dog owners by covering basic obedience, herding techniques, and troubleshooting tips. In this way, the tooth-safe herding ball empowers owners to effectively train their dogs, addressing a significant shortcoming in conventional herding training solutions.

The tooth-safe herding ball also improves urban accessibility for animal training, allowing dog owners to simulate herding activities in various environments such as parks or backyards. This versatility, combined with the comprehensive training kit, positions the tooth-safe herding ball as a unique and innovative solution in the pet training market.

In practice and in use, variations of the disclosed tooth-safe herding ball may be utilized in herding training of animals, such as dogs, or as a play toy for animals while also increasing accessibility, durability, and safety. The tooth-safe herding ball allows animals to engage in herding behaviors by pushing and chasing, replicating traditional herding activities in a safe and accessible manner.

In this way, the disclosed tooth-safe herding ball may provide superior durability compared to standard dog toys, capable of withstanding the rigorous physical activity required for herding training. The tooth-safe herding ball also improves over existing herding balls by utilizing soft yet durable materials, allowing for extended play and training sessions without risking dental damage.

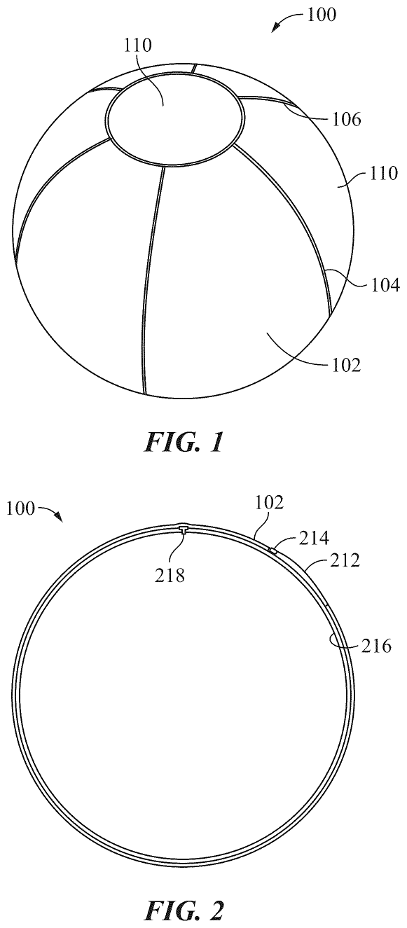

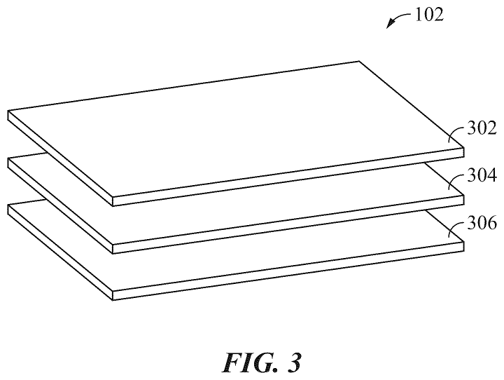

FIG. 1 illustrates a tooth-safe herding ball 100 including an outer layer 102 consisting of one or more panels 110 connected to one another via one or more seams 104. The one or more seams 104 may include double welt seams 106 or slot seams. In embodiments, the outer layer 102 is puncture-resistant comprising a tooth-safe and lightweight, soft structure configured to simulate sheep herding. The outer layer 102 may include a multi-layer waterproof construction, as depicted in FIGS. 2 and 3. In some embodiments, the outer layer 102 comprises a two-layer waterproof construction. In some embodiments, the outer layer 102 comprises a nylon and polyester blend fabric and wherein the outer layer 102 is at least one of blue or yellow to facilitate herding instincts based on dichromatic vision. In some embodiments, the outer layer comprises a material having a load limit ranging from approximately 1,100 lbs. to about 2,200 lbs. In some embodiments, the tooth-safe herding ball 100 is approximately 18 inches in diameter, approximately 25 inches in diameter, or approximately 30 inches in diameter, to replicate the approximate size of a sheep.

FIG. 2 illustrates a cross-sectional view of a tooth-safe herding ball 100 as depicted in FIG. 1. In embodiments, the inner layer 216 is puncture-resistant comprising a tooth-safe and lightweight, soft structure configured to simulate sheep herding. The inner layer 216 may include a through-hole configured to allow for filling the inner layer 216 is gas, such as air, and may include a valve and stopper plug 218 configured to plug the through-hole, thereby preventing gas from escaping the inner layer 216. The valve and stopper plug 218 may be a one way valve. In some embodiments, the inner layer 216 comprises heavy-duty PVC ranging in thickness from about 1,575 micrometers to about 2,330 micrometers in thickness. In some embodiments, the outer layer 102 may include a zip system comprising a zipper 212 and hood 214 configured to enclose the outer layer 102 around the inner layer 216.

FIG. 3 illustrates an exploded view of the outer layer 102 of a tooth-safe herding ball 100 depicted in FIGS. 1 and 2. The outer layer 102 may include a waterproof layer 302, a reinforced layer 304, and a denier liner 306. The outer layer 102 may include a nylon and polyester blend. In embodiments, the outer layer 102 may be blue or yellow to facilitate herding instincts based on dichromatic vision. In some embodiments, the outer layer 102 may include an encrypted nylon layer, a hydro-guarded tech shielding layer, and a flexiArmor denier lining.

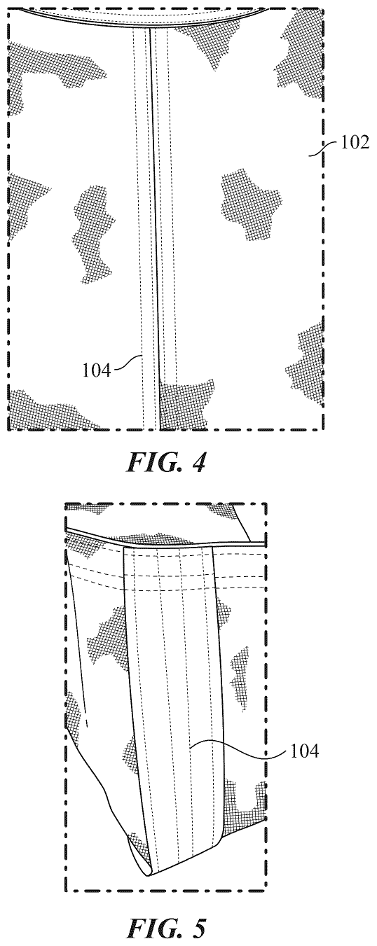

FIG. 4 illustrates a partial view of a tooth-safe herding ball including an outer layer enclosing the inner layer. The outer layer 102 may be made of multiple panels connected to one another via the seams 104 such as double welt seams or slot seams. In some embodiments, the outer panel 102 includes multiple panels connected to one another via shuttleless weaving and weft knitting of oxford polyester blend with a polyester lining and a carbon-8 waterproofing agent.

FIG. 5 illustrates a partial view of a tooth-safe herding ball depicting the underside of seam 104 that connect the panels of outer layer 102 to one another. In embodiments, the seams 104 may include a close wrap, edge wrap, or double stitching method. In some embodiments, the seams 104 may include nylon ribbon wrap and double seams.

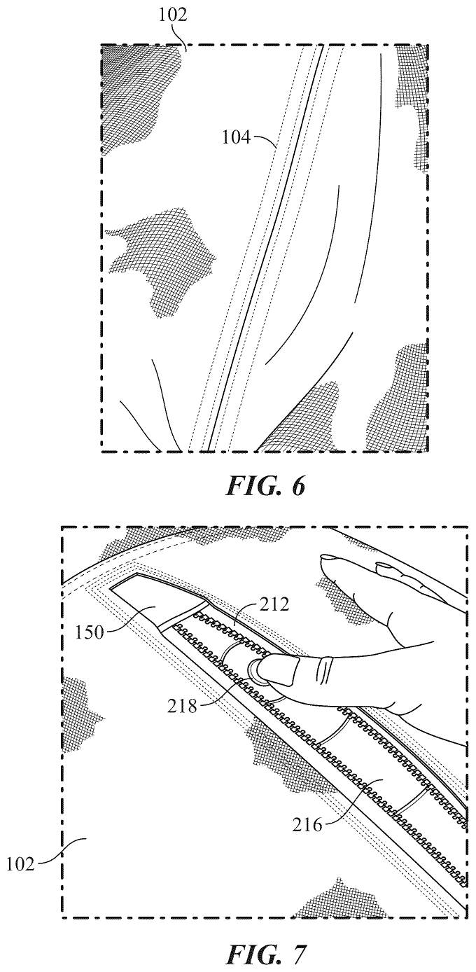

FIG. 6 illustrates a partial view of a tooth-safe herding ball including an outer layer enclosing the inner layer. The outer layer 102 may be made of multiple panels connected to one another via the seams 104. The outer layer 102 may be blue or yellow to facilitate herding instincts based on dichromatic vision.

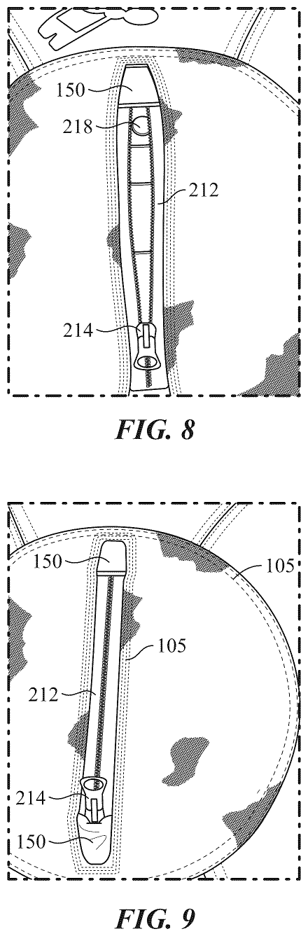

FIG. 7-9 illustrate partial views of a tooth-safe herding ball including an inner layer 216 enclosed by the outer layer 102 viz zipper 212. The outer layer 102 may include seams 104 as previously described. The inner layer 216 may include a material composition of approximately 50% PVC and 50% TBC. The inner layer 216 may include a valve and stopper plug 218 configured to plug a through-hole in the inner layer 216, thereby preventing gas from escaping the inner layer 216. A hood 150, corresponding to the hood 214 of FIG. 2, is constructed and arranged to cover a slider 214 and pull-tab of the zipper 212. The outer layer 102 panel that includes the zipper 212 may include a three seam seating to ensure the outer layer 102 does not separate into individual panels 110.

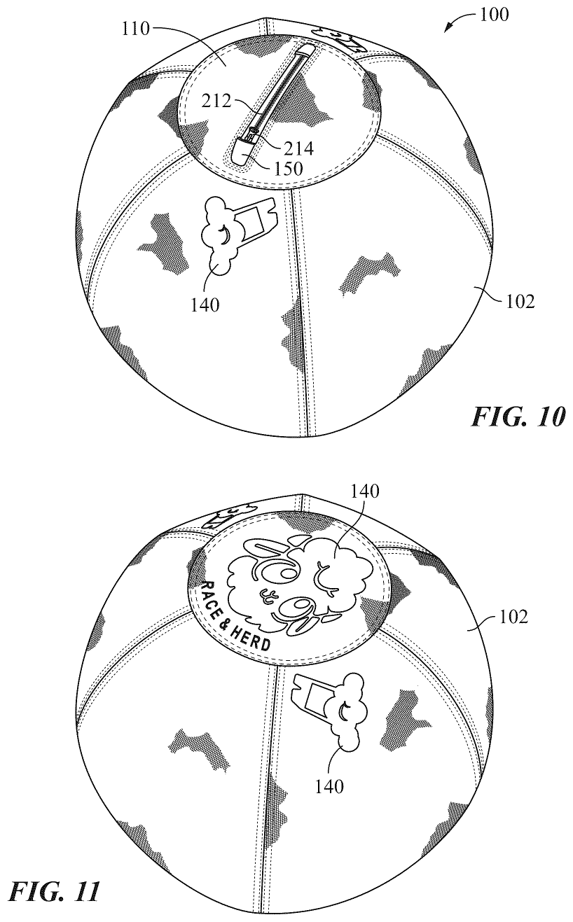

FIGS. 10 and 11 illustrates a tooth-safe herding ball 100 having an outer layer 102 including a decorative print 140, such as a printed image of a dog or sheep, to facilitate urban herding training without live sheep. In some embodiments, the decorative print 140 states “Race and Herd without sheep.”

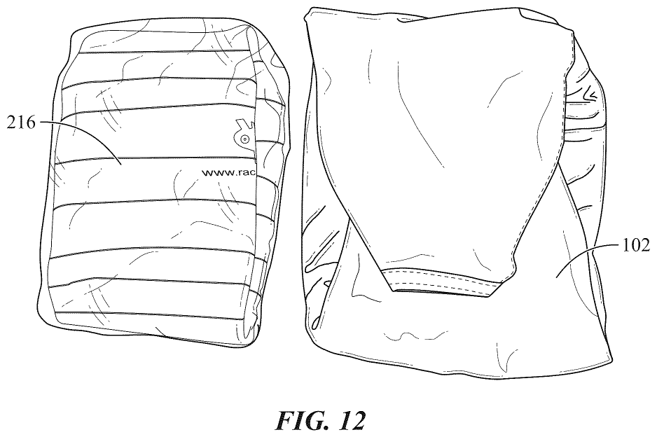

FIG. 12 illustrates a tooth-safe herding ball in an unassembled arrangement, including a deflated inner layer 216 and outer layer 102.

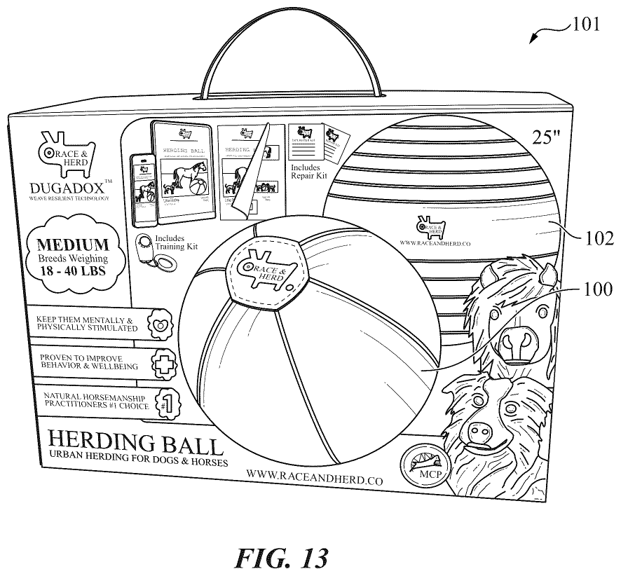

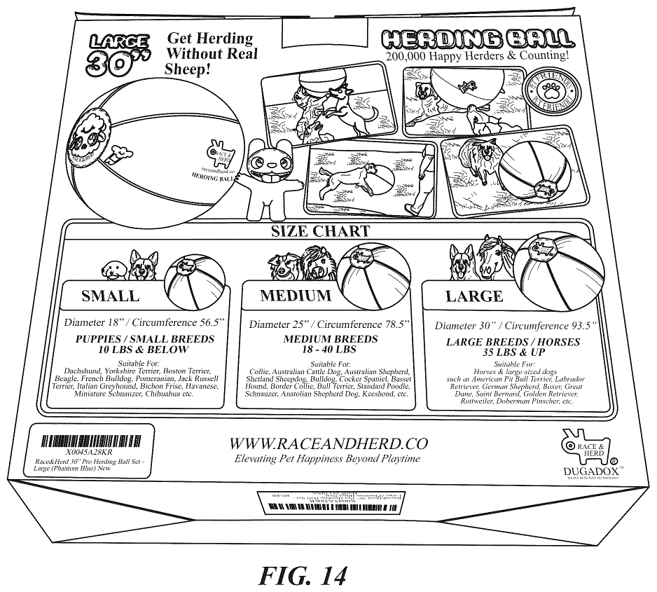

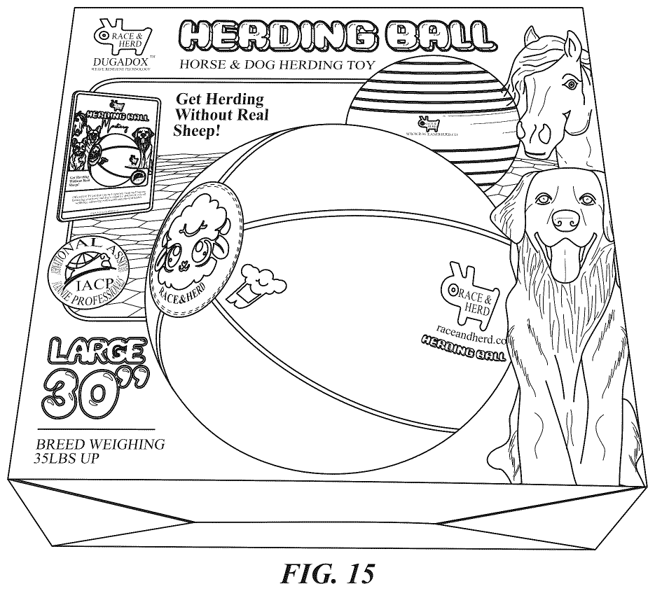

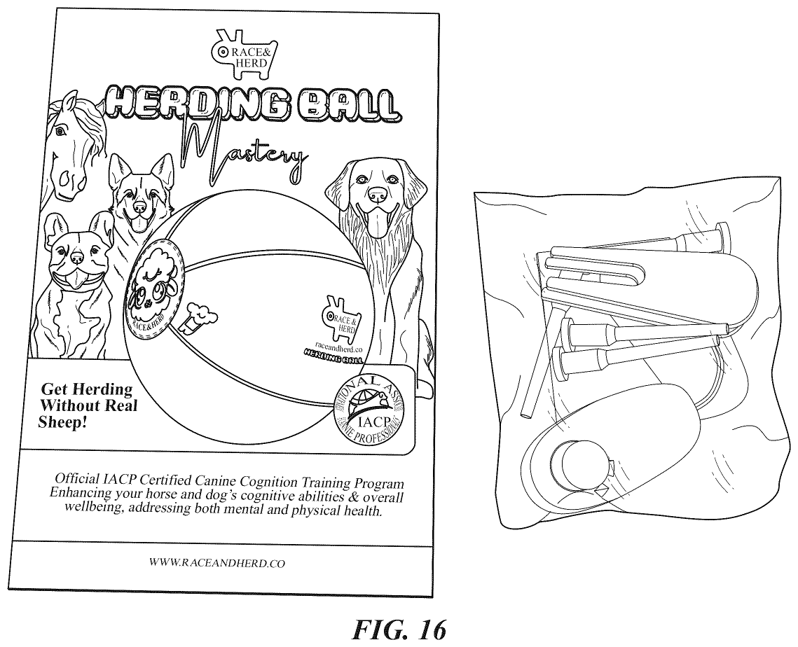

FIG. 13 illustrates a tooth-safe herding ball training kit including the tooth-safe herding ball 100 and training materials 900, which may include a training kit and manual, repair kit, software application instructions, etc.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

What is claimed is:

1. A tooth-safe herding ball for dog and horse well-being and mental stimulation by simulating herding instincts, comprising:
an inflatable polyvinyl chloride (PVC) inner ball comprising a valve and stopper plug configured for filling the inner ball with air; and
an outer layer at least partially surrounding the inner ball, wherein the outer layer comprises a zip system comprising a zipper having a slider and a pull tab, and a hood configured to enclose the outer layer around the inner ball, wherein the hood is constructed and arranged to cover the slider and the pull tab when the zip system is in a closed configuration.

2. The tooth-safe herding ball of claim 1, wherein the inner ball and the outer layer are puncture-resistant comprising a tooth-safe and lightweight, soft structure configured to simulate sheep herding.

3. The tooth-safe herding ball of claim 1, wherein the outer layer comprises a two-layer waterproof construction.

4. The tooth-safe herding ball of claim 1, wherein the outer layer comprises one or more double welt seams.

5. The tooth-safe herding ball of claim 1, wherein the outer layer comprises one or more slot seams.

6. The tooth-safe herding ball of claim 1, wherein the outer layer comprises a nylon and polyester blend fabric and wherein the outer layer blue facilitates herding instincts based on dichromatic vision.

7. The tooth-safe herding ball of claim 1, wherein the outer layer comprises a material having a load limit ranging from approximately 1,100 lbs. to about 2,200 lbs.

8. The tooth-safe herding ball of claim 1, wherein the inflatable PVC inner ball comprises heavy-duty PVC ranging in thickness from about 1,800 micrometers to about 2,330 micrometers in thickness.

9. The tooth-safe herding ball of claim 1, wherein the tooth-safe herding ball is approximately 18 inches in diameter.

10. The tooth-safe herding ball of claim 1, wherein the tooth-safe herding ball is approximately 25 inches in diameter.

11. The tooth-safe herding ball of claim 1, wherein the tooth-safe herding ball is approximately 30 inches in diameter.

12. A tooth-safe herding ball for dog and horse well-being and mental stimulation by simulating herding instincts, comprising:
a puncture-resistant inflatable 1,575 micrometer thick polyvinyl chloride (PVC) inner ball comprising a valve and stopper plug configured for filling the inner ball with air; and
a puncture-resistant outer layer at least partially surrounding the inner ball, wherein the outer layer comprises a nylon and polyester blend fabric, and a zip system comprising a zipper having a slider and a pull tab, and a hood configured to enclose the outer layer around the inner ball, wherein the hood is constructed and arranged to cover the slider and the pull tab when the zip system is in a closed configuration.

13. The tooth-safe herding ball of claim 12, wherein the outer layer comprises a two-layer waterproof construction.

14. The tooth-safe herding ball of claim 12, wherein the outer layer comprises one or more double welt seams.

15. The tooth-safe herding ball of claim 12, wherein the outer layer comprises one or more slot seams.

16. The tooth-safe herding ball of claim 12, wherein the outer layer comprises a material having a load limit of approximately 1,100-2,200 lbs.

17. The tooth-safe herding ball of claim 12, wherein the tooth-safe herding ball is approximately 18 inches in diameter.

18. The tooth-safe herding ball of claim 12, wherein the tooth-safe herding ball is approximately 25 inches in diameter.

19. The tooth-safe herding ball of claim 12, wherein the tooth-safe herding ball is approximately 30 inches in diameter.

20. A tooth-safe herding ball for dog and horse well-being and mental stimulation by simulating herding instincts, comprising:
a puncture-resistant inflatable 1,575 micrometer thick polyvinyl chloride (PVC) inner ball comprising a valve and stopper plug configured for filling the inner ball with air; and
a puncture-resistant outer layer at least partially surrounding the inner ball, wherein the outer layer comprises a nylon and polyester blend fabric comprising a load limit of approximately 1,100-2,200 lbs. and a zip system comprising a zipper having a slider and a pull tab, and a hood configured to enclose the outer layer around the inner ball, wherein the hood is constructed and arranged to cover the slider and the pull tab when the zip system is in a closed configuration.
